(19) United States
(12) Patent Application Publication
(10) Pub. No.: US 2013/0223729 A1
(43) Pub. Date: Aug. 29, 2013

(54) IDENTIFYING POINTS OF INTEREST IN AN IMAGE

(71) Applicant: Snell Limited, (US)

(72) Inventor: Jonathan Diggins, Buckinghamshire (GB)

(73) Assignee: SNELL LIMITED, Berkshire (GB)

(21) Appl. No.: 13/780,072

(22) Filed: Feb. 28, 2013

(30) Foreign Application Priority Data
Feb. 28, 2012 (GB) 1203431.0

(51) Int. Cl. G06T 7/00

(52) U.S. Cl. CPC G06T 7/0079
USPC 382/164; 382/173

(57) ABSTRACT

Points of interest are identified in an image to characterise that image by dividing the image tiles, each tile including adjacent pixels. The position of a pixel with an extremum value is determined or located within each tile and that extremal value is ascribed to the tile. A tile with an extremal value which is more extreme than that of all adjacent tiles is identified; and the position within the image of the pixel with the extremum value in that identified tile is selected as the point of interest.

### FIELD OF THE INVENTION

The present invention relates generally to the area of image processing, and especially to real-time applications in which such processing must be carried out and applied without slowing the image-transfer data-rate.

### BACKGROUND OF THE INVENTION

An image stream, such as is found, for example, in television and digital video applications, consists of a time-ordered series of individual images, or frames. The images are often two-dimensional images of a three-dimensional scene, but any number of dimensions can, in principle, be ascribed to an image. For example, a one-dimensional image might be a slice of a two-dimensional image, or it might be a section of a sound-track applicable to the frame. A three-dimensional image may be an image of a scene in which all three space dimensions are represented explicitly. More dimensions could be added, for example, by imaging the x, y and z motions or accelerations. The depth dimension can also be represented by combining frames taken from different viewpoints to provide a stereoscopic or holographic view of a scene. The present invention can be applied generally to all of these examples, but is not limited to them.

In some applications, it is necessary to determine how the scene represented in an image stream changes from one frame to the next, or between images taken at the same time from different points of view as in stereoscopic projection. This may be the case, for example, where there is a requirement to measure the integrity of the image stream for quality-control purposes, or for the efficient application of a data compression algorithm. In stereoscopic projection, the depth, related to the horizontal separation (disparity) of the left and right hand images, must be monitored and controlled within limits set by viewing comfort and health considerations. As the scene itself changes, or as the camera moves in translation, pan, tilt or zoom, so one frame in a stream changes with respect to those either side of it. The assumption is usually made that the rate of change of any such changes is slow compared to the frame rate. It is then likely that views of the same physical object appear in adjacent frames, giving the possibility that its position may be tracked from frame to frame and used as part of a monitoring, or quality assurance process applied to the image stream.

Identifying an object, or a region of interest, which can be tracked from frame to frame, is not trivial. Whereas the human eye and brain can carry out this task with relative ease (if not speed), a computational algorithm must suffer from the disadvantage that it can easily recognise only simple shapes such as edges, lines or corners, and these may not be present in a particular set of frames. However, there are nevertheless many algorithms known in the art which perform the task with varying levels of success. US 2011/0026763 to Diggins teaches how low-bandwidth audio-visual content signatures can generated from audio-video data streams and used for monitoring purposes. Knee, in GB 2474281, describes how image features may be identified from local data maxima in a frame. The present invention describes a relatively simple method which may be used to find points of interest in an image which is robust, but is also fast enough that it can be used in real-time applications.

### SUMMARY OF THE INVENTION

According to one aspect of the invention there is provided a method of identifying one or more points of interest in an image including a set of pixels in one or more dimensions, the method comprising the steps of
(a) dividing the image into one or more subsets of tiles including pixels which are adjacent to each other in the image;
(b) within each tile finding the positions of the pixels with the maximum and/or minimum values, and ascribing at least the maximum value or the minimum value to the tile;
(c) identifying a tile with said maximum or minimum ascribed value respectively greater than or less than the maximum or minimum ascribed values of all tiles which are adjacent to said tile in the image; and
(d) selecting the position within the image of the pixel with the maximum or minimum value in said identified tile as a point of interest.

An image, which is in one or more dimensions, may be thought of as a representation of the mapping of a video or audio scene onto a space which may have more, the same, or fewer dimensions than the scene being represented by the image. For example, a camera lens carries out the mapping of a three-dimensional scene onto a two-dimensional photograph which carries the image of the scene. Another example is the stereophonic image of the sound created by an orchestra which is recorded as two or more time-series representations of acoustic pressure on a digital or analogue recording medium such as a tape. When a time-ordered series of images, or snapshots, is made of a changing scene, the series is often divided into a sequence of frames, each of which may be thought of as a single image. As in the example above, video images are often two-dimensional images of a three-dimensional scene, but any number of dimensions can, in principle, be ascribed to an image. For example, a one-dimensional image might be a slice of a two-dimensional image, or it might be a section of a sound-track applicable to a frame. A three-dimensional image may be an image of a scene in which all three space dimensions are represented explicitly. More dimensions could be added, for example, by imaging the x, y and z motions or accelerations. The depth dimension can also be represented by combining frames taken from different viewpoints to provide a stereoscopic or holographic view of a scene. The present invention can be applied generally to all of these examples, but is not limited to them.

The term pixel is usually applied to a pictorial image such as a digital photograph or a frame in a video sequence. It describes a single element of the image and may represent colour, intensity and hue at that point in the image using numbers. According to the present invention, the term is applied more generally to mean any individual element of an image, whether audio or visual. For example, a digital TV camera may use a lens to map the three-dimensional visual scene onto a two-dimensional array of N photo-sensitive units which are constructed from a number of light-sensitive elements. Three or four such elements may be associated with every unit in the array, each being sensitive to a different aspect of the light falling on them, such as red, blue and green colours. The individual elements are “read out” from the array as voltages or currents which are subsequently converted into numbers, one set of numbers being assigned to its corresponding unit. In this case, each unit can be considered to be one pixel of the image, so that the image therefore consists of N pixels.

An audio image may be a frame of audio sample values, where the sample values represent acoustic pressure. The frame may comprise a defined number of samples, representing a defined time period. The dimensions of such an image could be sample number, defining the temporal position within the frame; and, track number, identifying a particular audio source or destination.

A tile consists of a set of pixels which are adjacent to each other in the image. Tiles may be of different shapes and sizes, consisting of at least one pixel and not more than the total number of pixels in the image. The whole image, or just a part of it, may be divided into tiles. The tiles may all be the same shape and size, or they may have different shapes and dimensions. Generally, however, the area of interest of the image may be covered by multiple tiles which are adjacent to each other, i.e. each tile shares a common edge or a single point with a neighbouring tile. In some circumstances, it may be an advantage to use tiles which overlap with each other. For example, an image may be divided into two different sets of tiles, each set covering the whole image, but using tiles of different sizes or shapes. Tiles in one set can overlap tiles in the other set. The method of the invention may be applied to both sets of tiles, and the list of points of interest extracted from the two sets of results.

### BRIEF DESCRIPTION OF THE DRAWINGS

Examples of the method and system according to the present invention will now be described with reference to the accompanying drawings, in which:

FIG. 1 shows a schematic diagram of an image;

FIG. 2 illustrates pixels within a tile;

FIG. 3 shows a point of interest in an image;

FIG. 4 shows exemplary tile positions within an image frame;

FIG. 5 shows a flow diagram of a process according to an embodiment of the invention; and

FIG. 6 is a block diagram schematically illustrating how an image stream is generated by a source (e.g., a video camera) and processed in an image processor (one or more microprocessors, computers, ASICs, etc.).

### DETAILED DESCRIPTION OF THE INVENTION

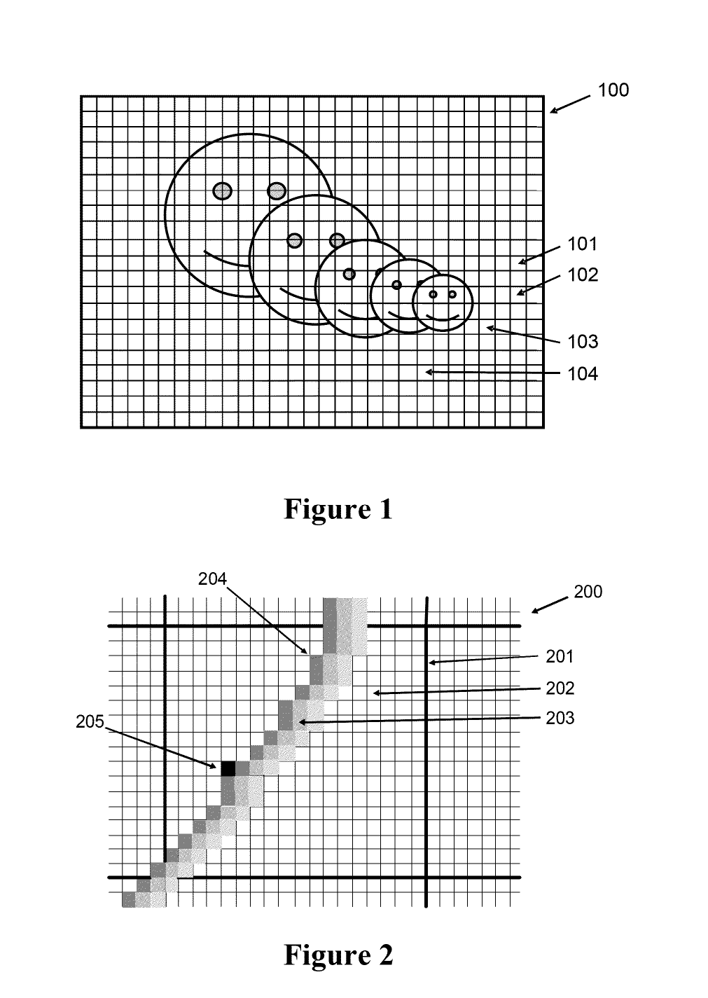

A schematic representation of an image is shown in FIG. 1 at 100. The image, in this case, is divided into rectangular tiles, examples of which are indicated at 101-104. Each tile comprises many pixels. Although the tiles are all the same size and shape in FIG. 1, it will be apparent to one skilled in the art that the tiles can be of any shape in principle, and need not be all the same size. However, if the whole image is to be covered, the tiles must fit together without gaps, and having rectangular tiles of the same size on a uniform grid constitutes an easy implementation.

A closer view 200 of a tile 201 is shown in FIG. 2. The individual pixels are represented as rectangles. Pixel 202 is part of the background and is white, whereas pixels 203 and 204 are part of a graded feature of a foreground object. According to the invention, a number is ascribed to each pixel which is representative of it. For example audio may be represented by a measure of acoustic pressure; video pixels may be characterised by colour, intensity, hue or some combination of these parameters. Typically, a video image may be represented as a gray level or luminance value, say between 0 and 1023, used as this representative number. The white background (e.g. pixel 202) might then be given the number 940, whilst the completely black pixel 205 may be given the number 64.

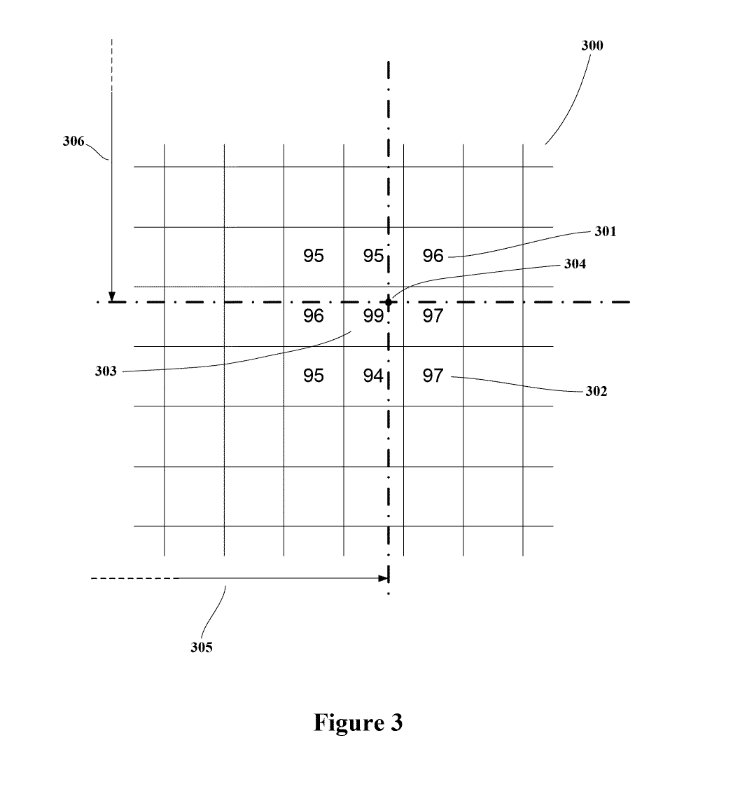

A representation of adjacent tiles in an image is shown in FIG. 3 at 300. The tile 303 has the number 99 ascribed to it using the method of the invention. That is, within tile 303, the maximum value of the pixels is 99, and position of the pixel with that value is indicated by the black dot 304. This is the number which is now ascribed to the whole tile 303. The same process is carried out on all the adjacent tiles, such as those indicated at 301 and 302, and the ascribed numbers are shown in the middle of each tile in FIG. 3. Clearly, in this case, tile 303 has a larger number ascribed to it than any of the ascribed numbers in the adjacent tiles. The pixel 304 therefore is selected as the point of interest, and its position within the whole image can be defined, according to Cartesian coordinates relative to an origin (not shown) at the top left-hand corner of the image, as a horizontal coordinate 305 and a vertical coordinate 306.

In video monitoring applications it is helpful to characterise a frame with a modest number of interest points, say 12, widely distributed over the area of the frame. This will enable the frame to be reliably identified at one or more points in a distribution chain and the relative positions of the points of interest to be used to identify scaling or translation of the identified picture. The method of the invention ensures that interest points cannot exist in adjacent tiles, and a grid of 18 tiles horizontally by 18 tiles vertically has been found suitable. Note that in this case the tiles will not be square, but will be the same shape as the frame itself. As will be explained, the tiles adjacent to the edge of the frame are discarded which means that the maximum possible number of interest points per frame is 128. It is not usually necessary to preserve the full spatial resolution of the video data; filtering and subsampling by up to a factor of 8 is typical. Of course this reduced spatial resolution reduces the storage and processing resources needed to create and use the feature points.

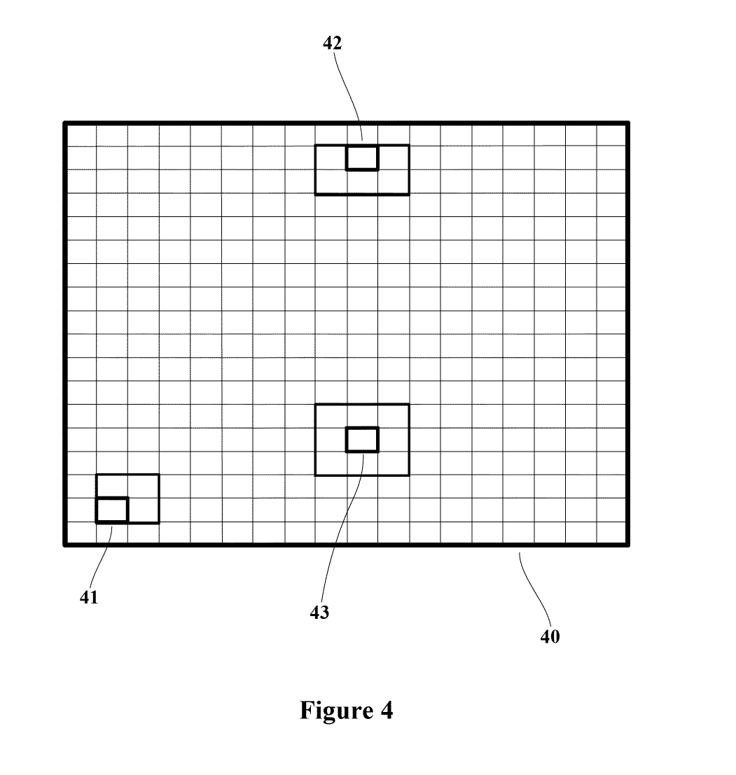

FIG. 4 shows the division of a frame 40 into 324 tiles. The 256 tiles which are not adjacent to any edge of the frame 40 are tested for the presence of feature points. As explained previously the test involves testing the extremal values (that is to say maximum or minimum values) for each tile with respect to values in the adjacent tiles. Only the non-frame-edge tiles are used in this test. Three examples of the tiles used are shown in FIG. 4. The corner tile 41 has 3 adjacent tiles; the non-corner edge tile 42 has 5 adjacent tiles; and, the tile not at a corner or edge 43 has 8 adjacent tiles.

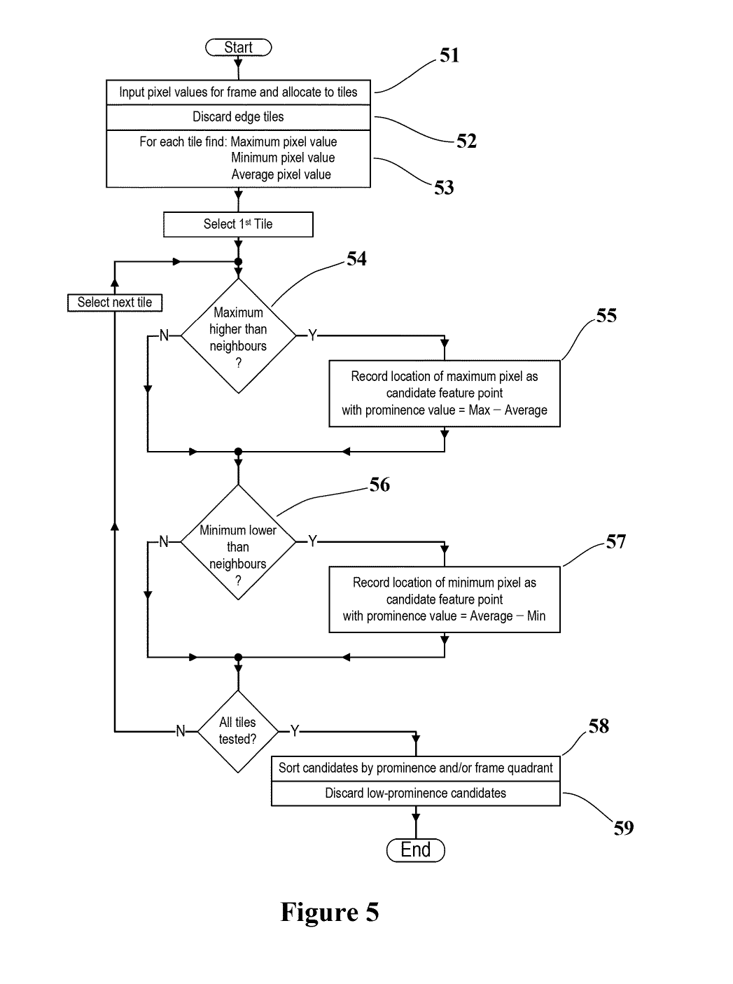

A flow-diagram of an exemplary process for determining a set of feature points for a video image according to an embodiment of the invention is shown in FIG. 5. Pixel values are input to the process, typically they will be presented in the order corresponding to a scanning raster, with horizontal timing references interposed to indicate the left and right edges of the active frame area. In step 51 each incoming pixel value is associated with the tile of which it forms part. In step 52 pixel values for the tiles adjacent to all four edges of the frame are discarded.

In step 53 the pixel values of each tile are evaluated to find: the respective maximum-value pixel; the respective minimum-value pixel; and, the respective average pixel value for the tile. These values are then analysed to determine a set of candidate feature points.

In step 54 the maximum value from the first tile is tested to see if it is higher than the maxima in the respective adjacent tiles (note that as edge tiles have been discarded they are not included in this comparison). If it is, the process moves to step 55, in which the location of the respective maximum in the tile under test is stored, together with its location, as a candidate feature point. A ‘prominence’ parameter, indicative of the visual significance of the candidate feature point is also stored. A suitable prominence parameter is the difference between the value of the maximum pixel and the average value of all the pixels in its tile.

In step 56 the pixel values of the tile are evaluated to find the respective minimum-value pixel for the tile, and if the minimum is lower than the minimum value for the adjacent tiles (excluding frame-edge tiles as before), the process moves to step 57 where the respective minimum value in the tile under test is stored, together with its location, as a candidate feature point. An associated prominence value, equal to the difference between the value of the minimum pixel and the average value of all the pixels in its tile is also stored.

Once all non-frame-edge tiles have been tested, the candidate feature points recorded in steps 55 and 57 are sorted according to their prominence values; and candidates with low prominence are discarded to reduce the number of feature point to a required number—say 12 feature point for the frame.

It is also helpful to sort the candidate feature points within defined regions within the frame. For example the frame can be divided in four quadrants and the candidates in each quadrant sorted separately. A minimum and a maximum number of feature points per quadrant can be set, subject to achieving the required total number of feature points for the frame. For example, if the candidates for a particular quadrant all have very low prominence, the two highest prominence candidates can be selected and additional lower prominence candidates selected in one or more other quadrants so as to achieve the required total number. This process is illustrated at step 59. Once the required number of feature points have been identified, the process ends.

A frame of data can thus be characterised by a set of feature point data where the data set comprises at least the position of each feature point within the frame and whether the feature point is a maximum value pixel or a minimum value pixel. In television images the positions of the feature points can be expressed as Cartesian co-ordinates in the form of scan-line numbers, counting from the top of the frame, and position along the line, expressed as a count of samples from the start of the line. If the frame has fewer or more than two dimensions then the positions of the feature points will be defined with fewer or more co-ordinates. For example feature points characterising a single-channel audio stream would comprise a count of audio samples from the start of the frame and a maximum/minimum identifier.

It is an advantage of the invention that each determination of an interest point depends only on the values of the pixels from a small part of the image (i.e. the tile being evaluated and its contiguous neighbours). This means that it is not essential to have all the pixels of the frame simultaneously accessible in the feature point identification process, with consequent reduction in the need for data storage.

When feature points for an image are available, a candidate image can be compared with that image by evaluating the feature points for the candidate image and comparing the two sets of feature points. Depending on the application, it may be helpful to detect a match even though a simple affine dimensional transformation has been applied to the candidate image. For example the feature points of one image may be shifted (positionally translated) or horizontally or vertically scaled versions of the feature point of the other image. Sometimes it will be helpful to declare a match when only part the respective images match and not all of the feature points can be matched.

When using feature points to compare images it is important that the respective methods of feature point identification used in analysing the respective images are substantially similar.

In some applications it may not be necessary to compare whole images. For example it may only be required to detect that a particular known object or graphic feature is present within an image. In this case, an arbitrary image containing the known object or graphic feature can be evaluated to detect interest points, and the interest points not forming part of the known object or feature discarded prior to being used in an image comparison process.

As the skilled person will appreciate from the above disclosure, the invention may be applied in various different ways. For example, it will usually be useful to low-pass filter the pixel value prior to identifying the feature points. The filter may operate in more than one dimension, though for images, horizontal filtering has been found adequate. The data may be down-sampled prior to analysis. Although this simplifies the feature point determination, because fewer pixels need to be analysed, it has the disadvantage of reducing the precision of the feature point co-ordinate values and thus risking ambiguity when sets of feature points are compared. The determination of feature points may use only maximum pixel values or only minimum pixel values.

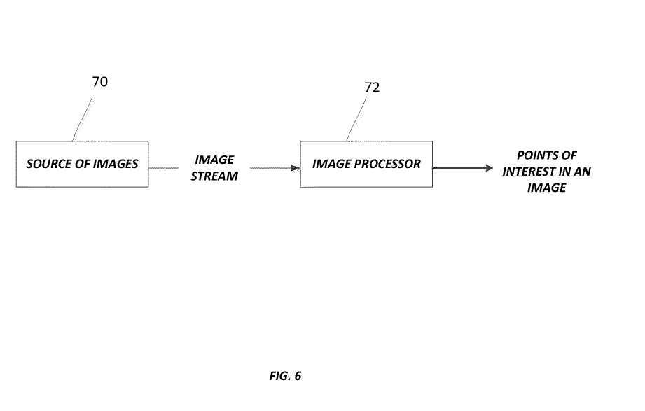

The skilled person will also appreciate that the general hardware for carrying out the described techniques will include (as is shown in FIG. 6) a source of images 70 such as a video or television camera that generates an image stream, and an image processor 72 that could, for example, take the form of an appropriately programmed microprocessor, a computer, ASICs, or other devices to carry out the techniques described. As noted above, “images” could include non-visual data such as audio data.

1. A method of identifying one or more points of interest in an image comprising of a set of pixels in one or more dimensions, the method comprising the steps of:
in an image processor, dividing the image into a plurality of tiles, each tile including pixels which are adjacent to each other in at least one of said one or more dimensions;
within each tile finding the position of a pixel with an extremum value, and ascribing that extremal value to the tile;
in the image processor, identifying a tile with an ascribed extremal value which is more extreme (in the sense being greater when the extremum value is a maximum and less when the extremum value is a minimum) than the ascribed extremum values of all tiles which are adjacent to said tile in at least one of said one or more dimensions; and
in the image processor, selecting as a point of interest the position within the image of the pixel with the extremum value in said identified tile.

2. A method according to claim 1 where the said image is a frame of video data and the pixel values are related to luminance or colour values.

3. A method according to claim 2 in which tiles at the edge of the frame are disregarded.

4. A method according to claim 1 where the said image is a frame of audio data and the pixel values are related to acoustic pressure.

5. A method according to claim 1 in which each said point of interest is represented by one or more co-ordinates of a pixel and identification of that pixel as a maximum or minimum value pixel.

6. A method according to claim 1 in which the representation of each said point of interest includes a prominence parameter.

7. A method according to claim 6 in which the said prominence parameter is a measure of the amount that the value of a pixel differs from the average pixel value for the pixels of the tile that includes that pixel.

8. A method according to claim 1 in which pixel values are low-pass filtered prior to the identification of the said point of interest.

9. A method of characterising an image in an image processor, the image including a set of pixels in one or more dimensions, the method comprising the steps of:
dividing the image into a plurality of tiles, each tile including pixels which are adjacent to each other in at least one of said one or more dimensions;
within each tile finding the position of a pixel with an extremum value, and ascribing that extremal value to the tile;
identifying a tile with an ascribed extremal value which is more extreme (in the sense being greater when the extremum value is a maximum and less when the extremum value is a minimum) than the ascribed extremum values of all tiles which are adjacent to said tile in at least one of said one or more dimensions;
selecting as a point of interest the position within the image of the pixel with the extremum value in said identified tile; and
associating the set of positions of the said points of interest with the said image.

10. A method according to claim 9 in which points of interest having low prominence are discarded.

11. A method according to claim 9 in which the said image is divided into a plurality of regions and the said image is characterised by at least one interest point in each region.

12. A non-transitory computer program product adapted to cause programmable apparatus to implement a method comprising the steps of:
dividing the image into a plurality of tiles, each tile including pixels which are adjacent to each other in at least one of said one or more dimensions;
within each tile finding the position of a pixel with an extremum value, and ascribing that extremal value to the tile;
identifying a tile with an ascribed extremal value which is more extreme (in the sense being greater when the extremum value is a maximum and less when the extremum value is a minimum) than the ascribed extremum values of all tiles which are adjacent to said tile in at least one of said one or more dimensions; and
selecting as a point of interest the position within the image of the pixel with the extremum value in said identified tile.

13. A method according to claim 12 where the said image is a frame of video data and the pixel values are related to luminance or colour values.

14. A method according to claim 13 in which tiles at the edge of the frame are disregarded.

15. A method according to claim 12 where the said image is a frame of audio data and the pixel values are related to acoustic pressure.

16. A method according to claim 12 in which each said point of interest is represented by one or more co-ordinates of a pixel and identification of that pixel as a maximum or minimum value pixel.

17. A method according to claim 12 in which the representation of each said point of interest includes a prominence parameter.

18. A method according to claim 17 in which the said prominence parameter is a measure of the amount that the value of a pixel differs from the average pixel value for the pixels of the tile that includes that pixel.

19. A method according to claim 12 in which pixel values are low-pass filtered prior to the identification of the said point of interest.

20. A method according to claim 12, comprising the further step of characterising the image by associating the set of positions of the said points of interest with the said image.
